(19) United States
(12) Patent Application Publication
(10) Pub. No.: US 2014/0323155 A1
(43) Pub. Date: Oct. 30, 2014

(54) RESPONDING TO AN UNAVAILABLE COMMUNICATION TARGET DEVICE

(71) Applicant: INTERNATIONAL BUSINESS MACHINES CORPORATION, Armonk, NY (US)

(72) Inventors: JAMES HEWITT, EASTLEIGH (GB); RICKY J. MOORHOUSE, PORTSMOUTH (GB); NEIL J. ORD, HEDGE END (GB); CAROLINE J. THOMAS, EASTLEIGH (GB)

(73) Assignee: INTERNATIONAL BUSINESS MACHINES CORPORATION, Armonk, NY (US)

(21) Appl. No.: 14/246,459

(22) Filed: Apr. 7, 2014

(30) Foreign Application Priority Data
Apr. 24, 2013 (GB) 1307394.5

(51) Int. Cl. H04W 4/02

(52) U.S. Cl. CPC H04W 4/023
USPC 455/456.3

(57) ABSTRACT

A communication method comprises attempting to connect a communication from a source to a target, detecting that the communication cannot be connected to the target, accessing location information for the target, accessing a contact list for the source, accessing location information for contacts on the contact list, detecting contacts on the contact list whose location is the same or close to the location of the target, and outputting one or more detected contacts whose location is the same or close to the location of the target.

### BACKGROUND

This invention relates to a communication method and to a device for carrying out the method. More specifically, the present invent relates to handling a failed communication session due to a communication target device being unavailable.

The use of mobile telephones and other similar communication devices is very widespread all over the world. The owner of a mobile telephone will usually have a list of contacts stored in their phone and when they wish to communicate directly with one of their contacts they can access the contact list and attempt to connect a telephone call to the selected contact. When someone is unreachable, for example due to a lack of network signal, a lack of sufficient battery power at the receiving device, or simply that the target of the telephone call is already using their phone or the contact has switched off their phone, then it is not possible to get through to the target. There are a number of known solutions to this problem, including the use of call divert, which diverts the incoming call to another number, however this requires manual configuration up front. A second known solution is to divert the incoming call to a voicemail, but this can result in a delay in communicating with the desired contact and is not an instant connection to the target. None of these solutions is ideal, when considering the problem of how to contact someone who cannot be reached on their mobile telephone.

### SUMMARY

In one embodiment of the present invention, a method and/or computer program product comprise: attempting to connect a communication from a source to a target; detecting that the communication cannot be connected to the target; accessing location information for the target; accessing a contact list for the source; accessing location information for contacts on the contact list; detecting contacts on the contact list whose location is the same or close to the location of the target; and outputting one or more detected contacts whose location is the same or close to the location of the target.

In one embodiment of the present invention, a communication device is arranged to: attempt to connect a communication from a source to a target; detect that the communication cannot be connected to the target; access location information for the target; access a contact list for the source; access location information for contacts on the contact list; detect contacts on the contact list whose location is the same or close to the location of the target; and output one or more detected contacts whose location is the same or close to the location of the target.

### BRIEF DESCRIPTION OF THE SEVERAL VIEWS OF THE DRAWINGS

Preferred embodiments of the present invention will now be described, by way of example only, with reference to the following drawings, in which:

FIG. 1 is a schematic diagram of mobile phones in a cellular network;

FIG. 2 is a further schematic diagram of mobile phones in a cellular network;

FIG. 3 is a schematic diagram of mobile phones in a single location;

FIG. 4 is a schematic diagram of a mobile phone; and

FIG. 5 is a flowchart of a communication method.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

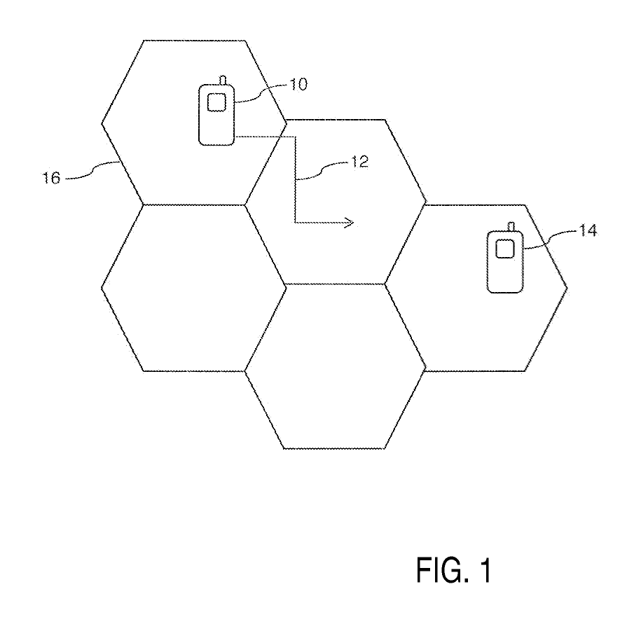

With reference now to the figures, FIG. 1 shows a source 10 of a communication 12, which is attempting to contact a target 14. The source 10 is a mobile phone 10. The user of the mobile phone 10 is attempting to contact another user's mobile phone 14. Normally this is done by the user of the mobile phone 10 accessing a contact list that is stored locally on the mobile phone 14. Other standard techniques such as using speed-dial, voice-dial or other shortcuts on the mobile phone 10 are also possible. The user of the mobile phone 10 selects the contact to whom they wish to speak and performs the necessary user interface steps on the mobile phone 10 in order to initiate the communication to the target mobile phone 14.

The two mobile phones 10 and 14 are shown in an arrangement of cells 16, in FIG. 1. The cells 16 are shown in a logical arrangement which corresponds roughly to the geographical arrangement of mobile phone base stations that are situated in the area in order to provide a wireless coverage of the locality. As is widely known, the identity of the cell in which the mobile phone 10 or 14 is located provides a rough geographic locator for the mobile phone (and hence the user of the phone), to a greater or lesser degree, depending upon the size of the cell 16 in question. Mobile phone cells 16 of a mobile phone network can vary widely in size.

The mobile phone network knows the location of the mobile phones 10 and 14, in order to rout calls to and from the mobile phones 10 and 14. If it is detected that the communication from the source 10 to the target 14 cannot be connected, then location information can be used to suggest an alternative target to the user of the mobile phone 10. The cells 16, if they are small enough, could be used as the basis for the location analysis, or further location based information could be accessed in order to decide on an alternative contact to be presented to the user of the mobile phone 10.

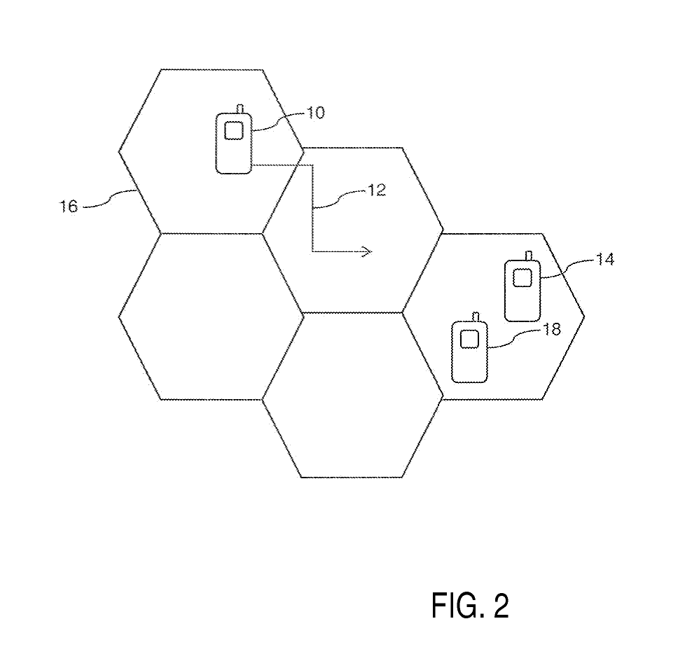

FIG. 2 shows a situation similar to FIG. 1, with the addition of a third mobile phone 18. The source 10 is still trying to attempt to connect a communication 12 to a target mobile phone 14 and the mobile phone 10 is able to detect that the communication 12 cannot be connected to the target 14, for whatever reason. The inability to connect to the target 14 could be as a result of the target mobile phone 14 being turned off, for example. The attempted communication 12 will fail to reach the target device 14 and will be either connected to a voicemail service for the mobile phone 14 or an unable to connect message will be returned.

In response to the detection of the fact that the communication 12 cannot be connected to the target mobile phone 14, the mobile phone 10 (the source of the communication 12) will access location information for the target 14. In this simple example, that location information is the identity of the cell 16 in which the mobile phone 14 (the original target) is located. More complex location schemes will be discussed below. The mobile phone 10 than accesses its own contact list and also accesses location information for one or more of the contacts on that contact list. The mobile phone 10 is able to detect contacts on the contact list whose location is the same or close to the location of the target mobile phone 14.

In this example, the mobile phone 18 belongs to a contact of the user of the mobile phone 10, the original source of the communication 12. The location of this mobile phone 18 is known to be in the same cell 16 as that of the original target 14 of the communication 12. There is then outputted to the user of the mobile phone 10, the detected contact 18 whose location is the same (or close to) the location of the target mobile phone 14. The user of the mobile phone 10 can then call the new detected contact 18 as an alternative, after being unable to connect to the original target 14.

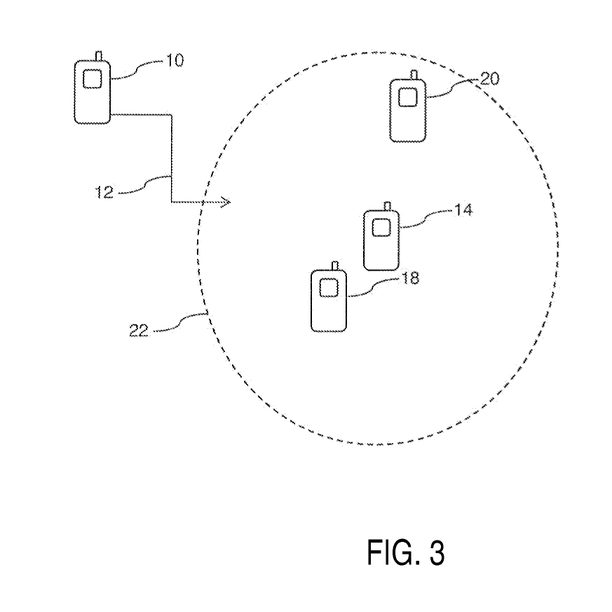

FIG. 3 shows another view of various mobiles phones in a locality, without reference to the mobile phone cells of FIG. 1 and FIG. 2. The mobile phones shown in these figures could all be in the same cell or could be in different cells. All of the mobiles phones are equipped with an accurate method of determining their locations, for example using GPS location services, which are commonly present on high specification mobile phones such as modern smartphones. The use of a GPS location service allows the location of a mobile phone with the service installed to be ascertained to a fairly high degree of accuracy, for example usually to within 10 meters.

As in the previous figures, the source mobile phone 10 is attempting to connect a communication 12 to a target mobile phone 14, however it is detected that the communication 12 cannot be connected to the target mobile phone 14. The source mobile phone 10 will then access location information for the target mobile phone 14 and for any other mobile phones that belong to contacts listed in a contact list of the source mobile phone 12. In this example, two additional mobiles phones 18 and 20 belong to contacts of the source mobile phone 10 and the location of these additional mobile phones 18 and 20 has been determined.

When detecting contacts on the contact list whose location is the same or close to the location of the target mobile phone 14, the source mobile phone 10 applies a predetermined proximity threshold 22 to the location of each contact relative to the location of the target 14. This threshold could be 25 meters, for example. In this case, both of the two alternatives are present within the threshold 22 and both of these alternative contacts can be presented to the user of the mobile phone 10, with the distances also shown to the user, to help assist the user in deciding who they should attempt to contact as an alternative.

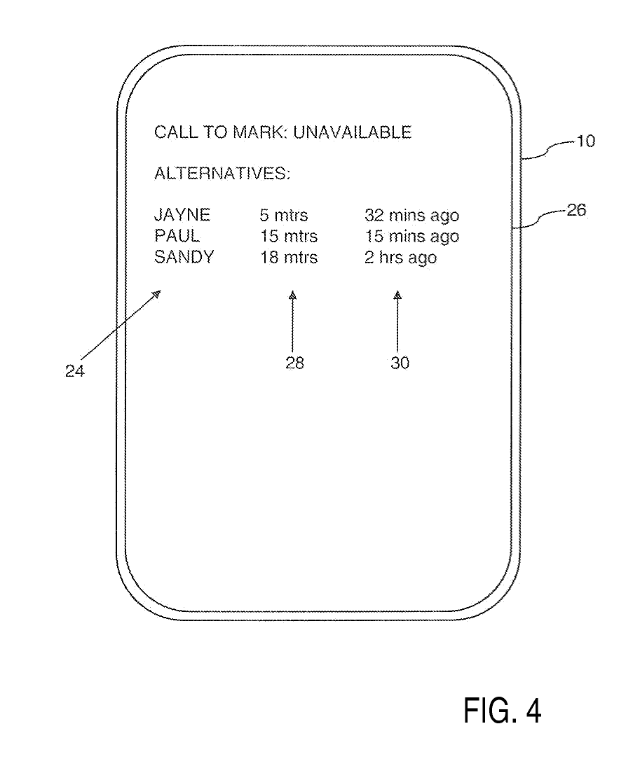

FIG. 4 shows the mobile phone 10 in more detail. This communication device 10 is arranged to present alternative contacts to the user of the mobile phone 10, if the original target of a communication is determined to be unavailable. The device 10 selects suitable candidates, where a candidate for redirect should be known to initiator, to be confirmed by the existence in contact lists and the candidate for redirect should be geographically close determined by a location service, or have “checked-in” to the same place within a set time. The mobile phone 10 is displaying a ranked list 24 of the detected contacts on a display device 26, the list 24 ranked according to proximity of the detected contact to the target.

The display device 26, which is showing the ranked list 24, also shows a distance measurement 28 and a time stamp 30 for each of the contacts shown in the ranked list 24. These two measures provide further information to the user of the mobile phone 10, which assists the user in deciding who they should try to contact as an alternative to the original target for their communication. The user can utilise the distance measurement in order to inform their own view as to whether each contact in the ranked list 24 is likely to be close enough to their original desired target to be worth contacting or not.

The time stamps 30 are provided so that the user of the mobile phone 10 can see the age of the respective location information. This again provides the user with more information about the contacts that are being provided within the ranked list 24. The user can judge from the time stamps 30 whether the location information is likely to be still accurate. This will depend upon the context of the location in which the target is to be found. For example, if the location is a restaurant, a time stamp that is two hours old might be judged to be no longer likely to be accurate, whereas if the location of the target is a park, then a two hour old time stamp for another contact may be judged to still be accurate.

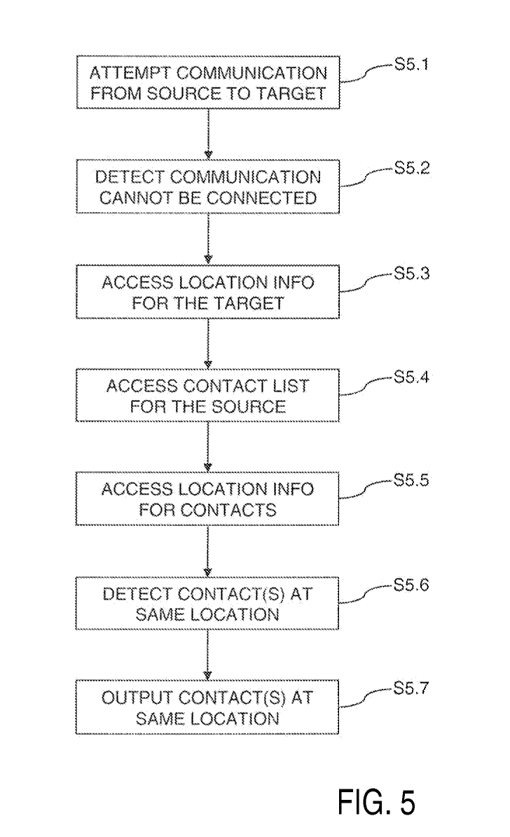

The method of operating the device 10 is summarised in FIG. 5. The method comprises the steps of, firstly step S5.1, which comprises attempting to connect a communication 12 from a source 10 to a target 14. The communication attempt 12 is generated entirely conventionally within the communication standard being used. For example, the user of the mobile device 10 selects an entry in their contact list and attempts to call that person. At step S5.2, it is detected that the communication 12 cannot be connected to the target 14. This detection is assumed to take place on the mobile device 10, so that the mobile device 10 is able to detect that the communication 12 has not been connected or has been rerouted to a voicemail, for example.

The next step in the method comprises step S5.3, which comprises accessing location information for the target. This location information can be in many different forms, such as mobile phone cell identity, GPS co-ordinates or simply the name of a business or building, depending upon the location service accessed. At step S5.4, the mobile device 10 accesses a contact list for the source 10 and at step S5.5 accesses location information for contacts on the contact list. The user's contact list is accessed and location information is sought for as many of the contacts on the contact list as possible. In this way, the mobile device 10 is able to build up a picture of the location of the user's other contacts.

At step S5.6, the mobile device 10 detects contacts on the contact list whose location is the same or close to the location of the target 14, and at step S5.7 outputs one or more detected contacts whose location is the same or close to the location of the target 14. The mobile device 10 provides the user with one or more candidates who the user may wish to contact as an alternative to the original target 14, who is currently unavailable. When multiple candidates are available, these could be sorted by closeness of relationship to the original target 14, using social networks or similar technology. The user is presented with one or more useful alternative contacts that are highly likely to be physically close to the original desired target 14.

Thus, as described herein and according to a first aspect of the present invention, there is provided a communication method comprising attempting to connect a communication from a source to a target, detecting that the communication cannot be connected to the target, accessing location information for the target, accessing a contact list for the source, accessing location information for contacts on the contact list, detecting contacts on the contact list whose location is the same or close to the location of the target, and outputting one or more detected contacts whose location is the same or close to the location of the target.

According to a second aspect of the present invention, there is provided a communication device arranged to attempt to connect a communication from a source to a target, detect that the communication cannot be connected to the target, access location information for the target, access a contact list for the source, access location information for contacts on the contact list, detect contacts on the contact list whose location is the same or close to the location of the target, and output one or more detected contacts whose location is the same or close to the location of the target.

According to a third aspect of the present invention, there is provided a computer program product on a computer readable for performing a communication method, the product comprising instructions for attempting to connect a communication from a source to a target, detecting that the communication cannot be connected to the target, accessing location information for the target, accessing a contact list for the source, accessing location information for contacts on the contact list, detecting contacts on the contact list whose location is the same or close to the location of the target, and outputting one or more detected contacts whose location is the same or close to the location of the target.

Owing to the invention, it is possible to provide an alternative contact to whom a communication can be made, who is very likely to be physically close to the person to whom the source is trying to contact. The user's device can be configured so that when someone is unreachable, the device uses location information, using a technology such as Google Latitude, Facebook Places, FourSquare, or mobile network data, for example, to see if any of the user's other contacts are in the same place as the target for the original communication. If such a contact is found, then this it is suggested to the user that an alternative contact is available. This provides a number of advantages in that the methodology can enable communication routes previously unavailable, improves the chances of reaching the person that the user is trying to contact, requires no prior knowledge of relationships and plans, saves time attempting to guess who might be nearby, and the communication is more likely to be instant. There is no need for the configuration of alternate numbers by the recipient and the method can leverage existing location services.

Preferably, the step of outputting one or more detected contacts whose location is the same or close to the location of the target comprises displaying a ranked list of the detected contacts, the list ranked according to proximity of the detected contact to the target. If the user attempts to reach a target contact that is currently unavailable, then the user can be presented with the possible alternative contacts in a ranked list, with the person who is physically closest to their intended target at the top of the list. This gives the user the chance to see which of their contacts is physically closest to the person that they are trying to reach. Distance information could also be carried in the ranked list, in order to assist the user in making their decision about who they should call as an alternative.

Advantageously, the step of detecting contacts on the contact list whose location is the same or close to the location of the target comprises applying a predetermined proximity threshold to the location of each contact relative to the location of the target. For those contacts whose location is known, their location can be compared to the location of the target contact using a predetermined proximity threshold. For example, if contact location is being determined using GPS co-ordinates, for example, then a 15 m radius around the target contact may be applied, and only those contacts who are within the 15 m radius are considered as possible alternatives that are presented to the user, once they have failed to reach their original target contact.

Ideally, the method further comprises accessing relationship information for the target and the contacts on the contact list and removing those contacts on the contact list that have no relationship with the target. The user's device could additionally use relationship information when filtering the user's contact list to locate contacts that are physically close to the target contact. This is because if a contact is not known to the target contact, there is little point in suggesting them as an alternative contact, even if they are physically close to the target contact, since they will not actually know the person who the user is trying to reach. This ensures that the list of alternative contacts presented to the user contains people who are known to the target contact and are in close physical proximity to the target contact.

Preferably, the method further comprises accessing a time stamp for each of the accessed location information for contacts on the contact list and removing those contacts on the contact list for which the time stamp is older than a predetermined time period. Location information for the user's contacts is not necessarily up-to-date, depending upon the source of the location information and the method of acquiring that location information. For that reason it is preferable if time data can also be captured in reference to the location information. This means that where the user's device has accessed location information for an alternative contact, it will also acquire a time stamp for that location information and will not use contacts for whom the location information is considered to be too old. The predetermined time period might be one hour, for example, but could be set by the user. The time information can be provided to the user along with the location information about those alternative contacts in order that the user can make their own decision about who they should contact.

What is claimed is:

1. A communication method comprising:
attempting, by a hardware communication device, to connect a communication from a source to a target;
detecting, by one or more processors, that the communication cannot be connected to the target;
accessing, by one or more processors, location information for the target;
accessing, by one or more processors, a contact list for the source;
accessing, by one or more processors, location information for contacts on the contact list;
detecting, by one or more processors, contacts on the contact list whose location is the same or close to the location of the target; and
outputting, by one or more processors, one or more detected contacts whose location is the same or close to the location of the target.

2. The method according to claim 1, wherein said outputting one or more detected contacts whose location is the same or close to the location of the target comprises displaying a ranked list of the detected contacts, the list ranked according to proximity of the detected contact to the target.

3. The method according to claim 1, wherein said detecting contacts on the contact list whose location is the same or close to the location of the target comprises applying a predetermined proximity threshold to the location of each contact relative to the location of the target.

4. The method according to claim 1, and further comprising:
accessing relationship information for the target and the contacts on the contact list and removing those contacts on the contact list who have no relationship with the target.

5. The method according to claim 1, further comprising:
accessing a time stamp for each accessed location information for contacts on the contact list and removing those contacts on the contact list for whom the time stamp is older than a predetermined time period.

6. A communication device arranged to:
attempt to connect a communication from a source to a target;
detect that the communication cannot be connected to the target;
access location information for the target;
access a contact list for the source;
access location information for contacts on the contact list;
detect contacts on the contact list whose location is the same or close to the location of the target; and
output one or more detected contacts whose location is the same or close to the location of the target.

7. The device according to claim 6, wherein the device is arranged, when outputting one or more detected contacts whose location is the same or close to the location of the target, to display a ranked list of the detected contacts, the list ranked according to proximity of the detected contact to the target.

8. The device according to claim 6, wherein the device is arranged, when detecting contacts on the contact list whose location is the same or close to the location of the target, to apply a predetermined proximity threshold to the location of each contact relative to the location of the target.

9. The device according to claim 6, wherein the device is further arranged to access relationship information for the target and the contacts on the contact list and remove those contacts on the contact list who have no relationship with the target.

10. The device according to claim 6, wherein the device is further arranged to access a time stamp for each accessed location information for contacts on the contact list and remove those contacts on the contact list for whom the time stamp is older than a predetermined time period.

11. A computer program product for handling a call to a target that cannot be connected to, the computer program product comprising a computer readable storage medium having program code embodied therewith, the program code readable and executable by a processor to perform a method comprising:
attempting to connect a communication from a source to a target;
detecting that the communication cannot be connected to the target;
accessing location information for the target;
accessing a contact list for the source;
accessing location information for contacts on the contact list, detecting contacts on the contact list whose location is the same or close to the location of the target; and
outputting one or more detected contacts whose location is the same or close to the location of the target.

12. The computer program product according to claim 11, wherein said outputting one or more detected contacts whose location is the same or close to the location of the target comprises displaying a ranked list of the detected contacts, the list ranked according to proximity of the detected contact to the target.

13. The computer program product according to claim 11, wherein said detecting contacts on the contact list whose location is the same or close to the location of the target comprises applying a predetermined proximity threshold to the location of each contact relative to the location of the target.

14. The computer program product according to claim 11, wherein the method further comprises:
accessing relationship information for the target and the contacts on the contact list and removing those contacts on the contact list who have no relationship with the target.

15. The computer program product according to claim 11, wherein the method further comprises:
accessing a time stamp for each accessed location information for contacts on the contact list and removing those contacts on the contact list for whom the time stamp is older than a predetermined time period.
